(19) United States
(12) Patent Application Publication
(10) Pub. No.: US 2025/0311841 A1
(43) Pub. Date: Oct. 9, 2025

(54) TOOTHBRUSH AND CARTRIDGE FOR DISPENSING TOOTHPASTE

(71) Applicant: Matthew Faolan Lovato, Exeter, CA (US)

(72) Inventor: Matthew Faolan Lovato, Exeter, CA (US)

(21) Appl. No.: 19/171,243

(22) Filed: Apr. 5, 2025

Related U.S. Application Data
(60) Provisional application No. 63/631,771, filed on Apr. 9, 2024.

(51) Int. Cl. A46B 11/00; A46B 9/04; A61C 17/22

(52) U.S. Cl. CPC A46B 11/0031; A46B 9/04; A46B 11/0065; A46B 11/0086; A61C 17/227

(57) ABSTRACT

An apparatus for dispensing toothpaste includes a toothbrush and a cartridge. The toothbrush includes a head, a body extending from the head, the body including a toothbrush cavity, a gear configured to advance the toothpaste, and a hatch configured to create a positive pressure into the cartridge forcing the cartridge forward. The hatch forming a tapered seal within the front of the toothbrush cavity. The cartridge is configured for providing toothpaste to the toothbrush. The cartridge includes one or more gears, a plunger, a cartridge tube, and a seal. The gear makes contact with an outer gear located on the body of the toothbrush. The plunger rotates forward as the gears are advanced, pushing the toothpaste from the cartridge to the end of the toothbrush. The cartridge tube has two or more indentations on a first end that are configured to stop the cartridge tube from rotating within the toothbrush.

### TECHNICAL FIELD

The present application relates generally to toothbrushes and, more specifically, to a toothbrush and associated cartridge paste dispenser.

### BACKGROUND

Oral hygiene is a multistep process including securing toothpaste/toothbrush, unscrewing the toothpaste lid, finding a safe place for the lid, applying toothpaste to the brush, then carefully securing the lid to screw onto the toothpaste container before placing everything back into its specified location. Accordingly there is a need for improvements in toothbrush technology

### SUMMARY

In accordance with aspects of the present disclosure an apparatus for dispensing toothpaste including a toothbrush and a cartridge is presented. The toothbrush includes a head, a body extending from the head, the body including a toothbrush cavity, a gear configured to advance the toothpaste. The gear may be manually driven or electrically driven. Included is a hatch enabling a cartridge to be inserted into the toothbrush body. The hatch may be configured to create a positive pressure into the cartridge forcing the cartridge forward and creating a tapered seal within the front of the toothbrush cavity. The cartridge is configured for providing toothpaste to the toothbrush. The cartridge includes one or more gears, a plunger, a cartridge tube, and a seal. The cartridge gear makes contact with an outer gear located on the body of the toothbrush. The plunger rotates forward as the gears are advanced, pushing the toothpaste from the cartridge to the end of the toothbrush. The cartridge tube has indentations on a first end that are configured to stop the cartridge tube from rotating within the toothbrush.

Further details and aspects of exemplary embodiments of the present disclosure are described in more detail below with reference to the appended drawings.

### BRIEF DESCRIPTION OF THE DRAWINGS

A better understanding of the features and advantages of the disclosed technology will be obtained by reference to the following detailed description that sets forth illustrative embodiments, in which the principles of the technology are utilized, and the accompanying drawings of which:

FIG. 1 is a diagram illustrating a toothbrush with a cutout providing access to a gear, in accordance with aspects of the disclosure;

FIG. 2 is a side cutaway diagram illustrating the toothbrush of FIG. 1, in accordance with aspects of the disclosure;

FIG. 3 is a side cutaway diagram illustrating a cartridge of the toothbrush of FIG. 1, in accordance with aspects of the disclosure;

FIGS. 4A and 4B are side views of a toothbrush head illustrating a cross sectioned hose cap of FIG. 1, in accordance with aspects of the disclosure;

FIG. 5 is a side view of a floss roll, a floss cap and a close-up of the cartridge of FIG. 2, in accordance with aspects of the disclosure;

FIG. 6 is a side view illustrating a motor of the toothbrush of FIG. 1, in accordance with aspects of the disclosure;

FIG. 7 is a side view illustrating a floss roll of the toothbrush of FIG. 1 and a dissected view of the toothbrush of FIG. 6, in accordance with aspects of the disclosure;

FIG. 8 is a side view close up illustrating the working mechanisms of the bottom of the toothbrush of FIG. 7, in accordance with aspects of the disclosure;

FIG. 9 is a side perspective view illustrating the motor of the toothbrush of FIG. 7, and the internal gears of the cartridge of FIG. 7, in accordance with aspects of the disclosure;

FIG. 10 is side perspective a close up view illustrating the internal gears of the cartridge and motor of FIG. 7, in accordance with aspects of the disclosure; and

FIG. 11 is a side view illustrating a twist and click locking mechanism of a toothbrush head of the toothbrush of FIG. 7, in accordance with aspects of the disclosure;

### DETAILED DESCRIPTION

The present application relates to systems and methods for hosting a virtual reality environment.

For the purpose of promoting an understanding of the principles of the present disclosure, reference will now be made to exemplary embodiments illustrated in the drawings, and specific language will be used to describe the same. It will nevertheless be understood that no limitation of the scope of the present disclosure is thereby intended. Various alterations, rearrangements, substitutions, and modifications of the features illustrated herein, and any additional applications of the principles of the present disclosure as illustrated herein, which would occur to one skilled in the relevant art and having possession of this disclosure, are to be considered within the scope of the present disclosure.

The disclosed toothbrush enables users to skip a multistep process by integrating toothpaste cartridges into the toothbrush body allowing users to twist a small gear which applies toothpaste to the brush therefore alleviating the need for a multi-process routine while creating a more user friendly experience at the beginning and end of each person's day. Another effect of the disclosed toothbrush is simplifying oral hygiene as it relates to the traveling experience. This toothbrush is designed to solve the problem of messy, inconvenient toothpaste application by integrating a clean, controlled dispensing mechanism directly into the toothbrush. It also addresses hygiene and portability concerns by using a sealed, replaceable cartridge system that ensures consistent toothpaste flow and reduces contamination.

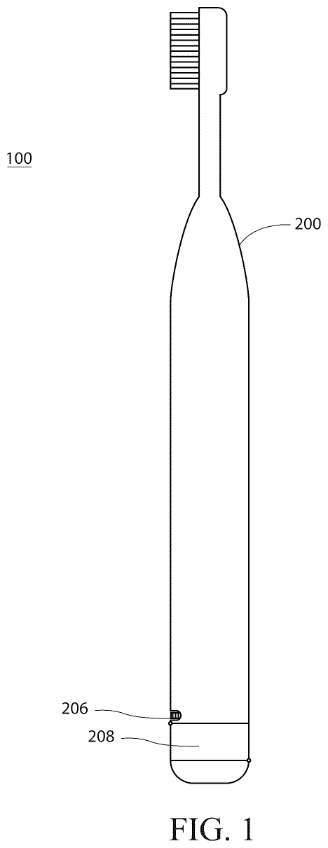

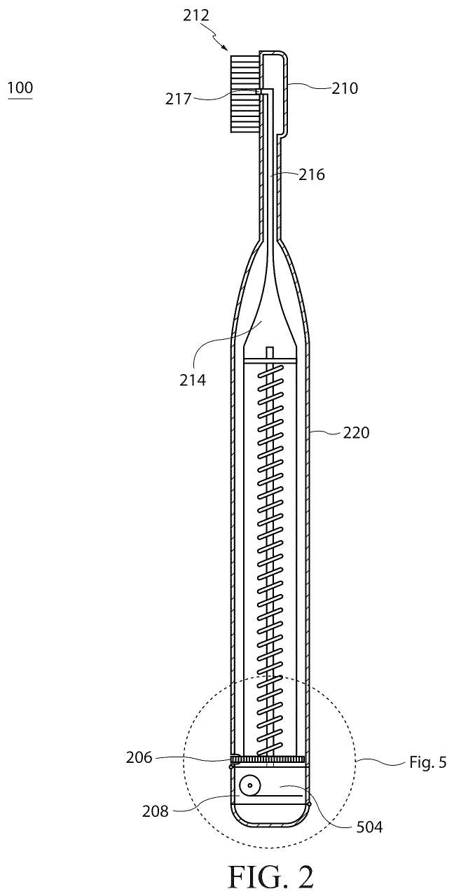

Referring to FIGS. 1 and 2, an apparatus for dispensing toothpaste 100 is shown. The apparatus 100 generally includes a toothbrush 200 and a cartridge 300 configured for providing toothpaste to the toothbrush 200 for dispensing. The toothbrush 200 generally includes a head 210, a body 220 extending from the head 210, a small cutout 206 and a hatch 208 enabling the insertion of the cartridge.

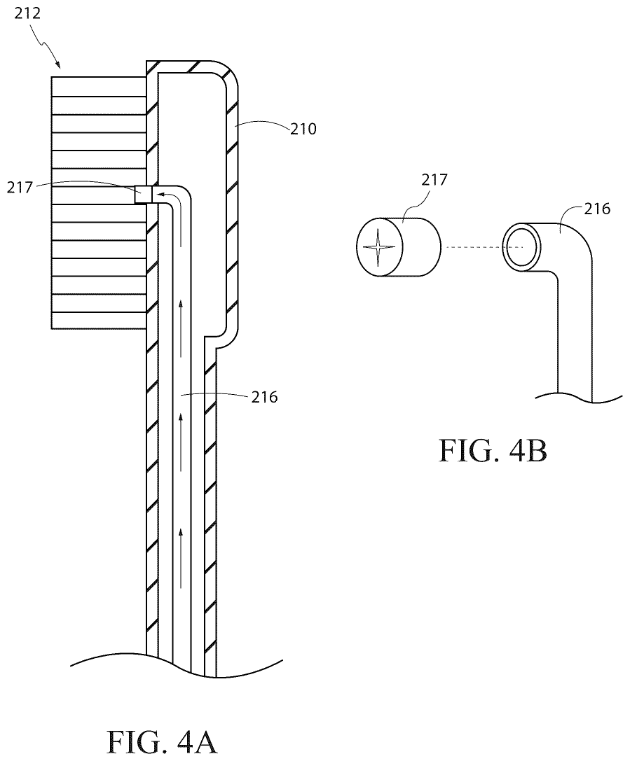

Referring to FIG. 2, the head 210 includes bristles 212, a tapered cavity 214, and a tube 216 extending from the tapered cavity 214 to the bristles 212. In aspects, the tube 216 may be a small flexible tube ranging from about 2 mm to about 10 mm. The tube 216 extends to the end of the bristles 212 and is configured for dispensing toothpaste. The tube 216 includes a proximal end and a distal end. The distal end of the tube 216 includes a cap 217 (FIG. 4B) with cross slices configured to stop toothpaste from oozing out. The cap 217 may be made from any suitable soft material such as soft plastic and/or rubber. The bristles 212 may range in softness from super soft, soft, medium, and stiff.

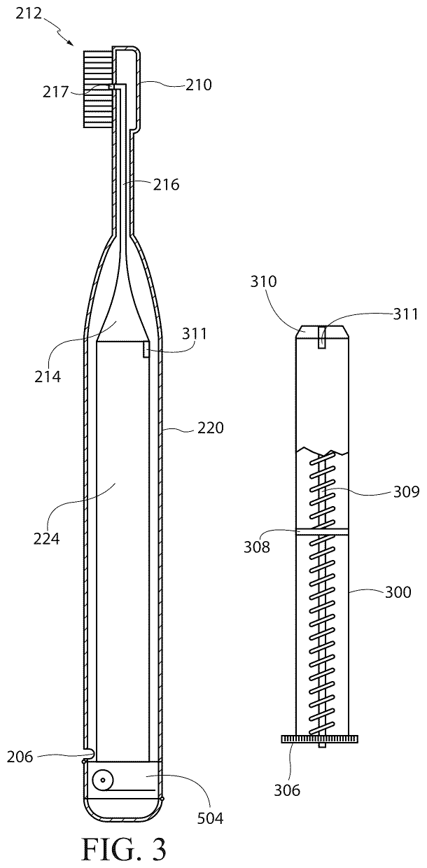

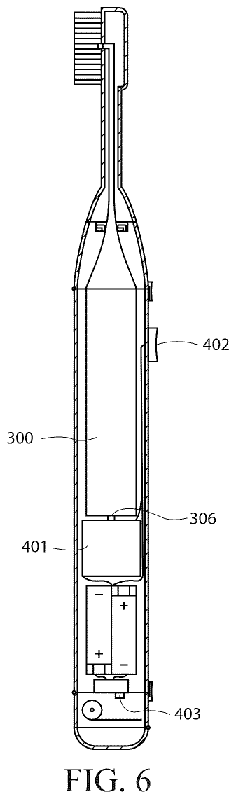

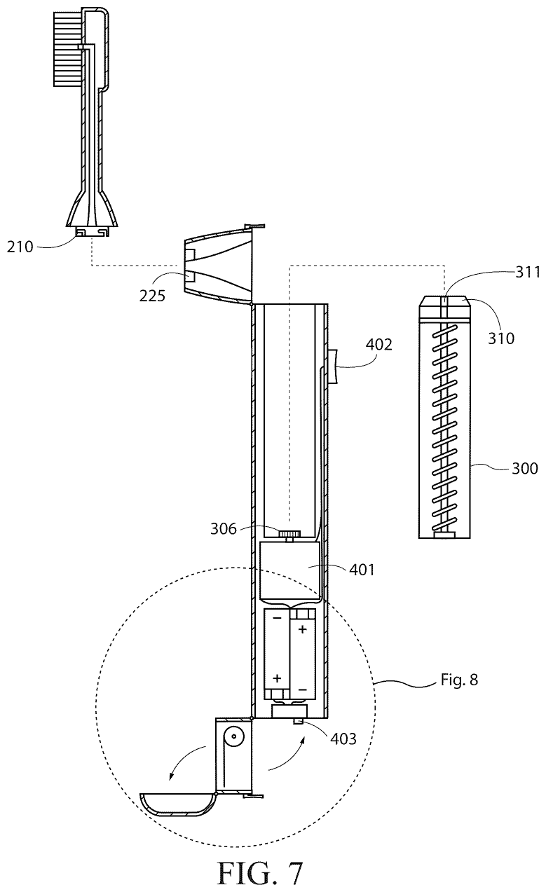

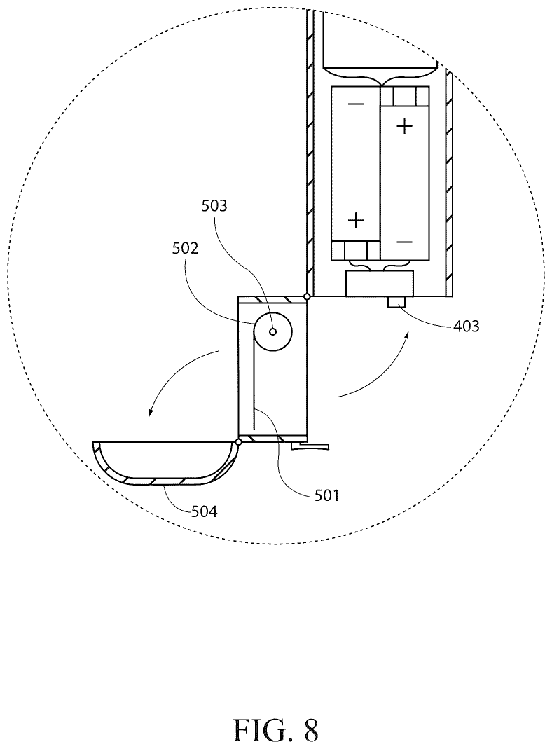

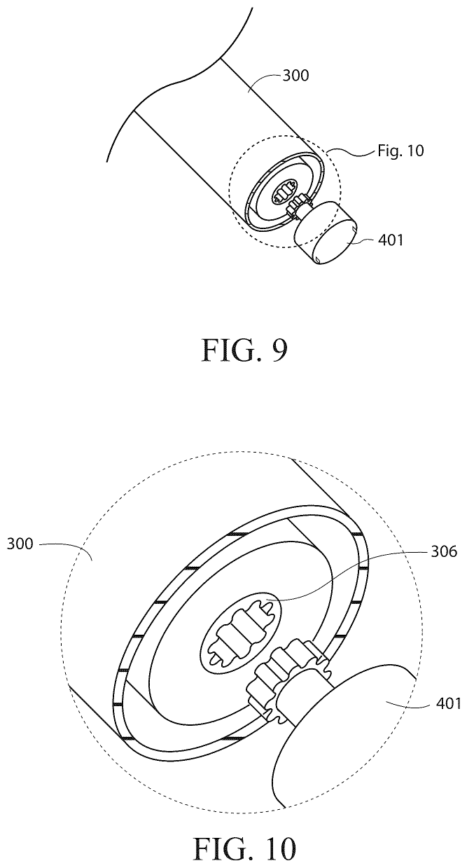

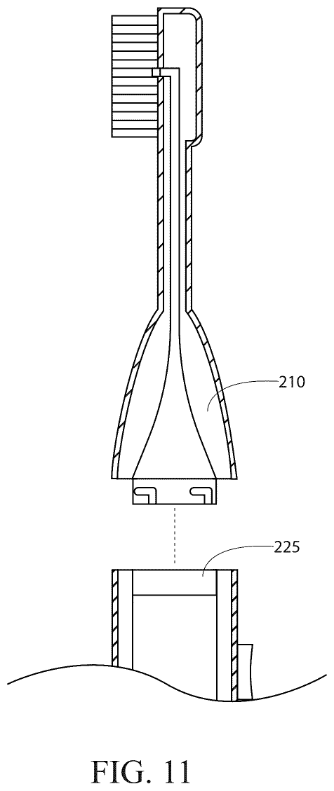

The body 220 has a cavity 224 on the inside configured to house the cartridge 300. The body cavity 224 is just big enough to allow the cartridge to slide in and fit snug. The body 220 has a cutout 206 allowing an outer gear, attached to the cartridge 306, to pass through the body allowing physical contact with the gears located on the cartridge (FIG. 3). The body 220 may be configured to house an electric motor 401 (FIG. 6) in the body 220 of the toothbrush 200. The electric motor 401 may be a low rpm motor. The electric motor 401 may be activated via a pushbutton 402 which is routed to an on off switch 403 enabling it to activate the electric motor. The electric motor includes a gear which inserts into the replaceable cartridge gear 306 (FIG. 10) enabling the rotation of the cartridge spindle 309 in turn dispensing toothpaste to the end of the bristles 212 (FIG. 4A). The power switch 403 may be located at the base of the toothbrush 200 but not limited to this location. The dispensing push button 402 may be located on the external body of the toothbrush 200. The electric driven toothbrush 200 may have a floss cap 208 containing a floss roll and floss cutter 501 (FIG. 8) located at the back of the toothbrush 200 but not limited to this location. The floss cap 208 covers the on/off switch ensuring unintentional switching does not occur. In the body 220 of the toothbrush 200 is an opening enabling the cartridge 300 to be inserted into the body. The floss cap 208 covers said opening. The opening for inserting the cartridge may be located towards the top or the bottom of the toothbrush 200. The top opening for inserting the cartridge may be secured by a latch, threads or a twist and lock. The end of the body 220 contains an insert 225 (FIG. 11) enabling the head 210 of the toothbrush 200 to be replaced. The toothbrush head 210 may attach with threads or a twist and click locking mechanism. The replaceable head 210 of the toothbrush 200 may contain a hollow tube 216 allowing toothpaste to be dispensed into the bristles 212.

Referring to FIG. 3, the cartridge 300 of the apparatus 100 of FIG. 1 is shown. The cartridge 300 generally includes a gear 306, a plunger 308, a cartridge tube 300, and a tapered seal 310 but not limited to a tapered seal. O-rings may be used to aid in the seal. The gear 306 is located on the back of the cartridge 300 and attached to an inner spindle 309. The gear 306 may protrude through the toothbrush body. (FIG. 2) located on the body 220 of the toothbrush 200. The gear 306 on the cartridge 300 may be arranged as a set of different sizes, orientations and specifications to best allow the rate of toothpaste dispensed and to maintain the optimal contact with the gear within the body 220 of the toothbrush 200. The gear 306 may be internal (FIG. 10) or external enabling a gear to be inserted into the cartridge 300.

The hatch 208 (FIG. 2) is configured to create a positive pressure into the cartridge 300 forcing the cartridge 300 forward and creating a tapered seal 310 within the front of the toothbrush body cavity 224.

The plunger 308 rotates around the inner spindle 309 which attaches to the gear 306. The plunger 308 rotates forward as the gears 306 are turned, pushing the toothpaste from the cartridge 300 to the end of the toothbrush 200.

The cartridge tube 300 is cylinder shaped and is configured to fit into the cavity of the toothbrush body 220. The cartridge tube 300 has one or more indentations 311 on a first end in order to stop the cartridge tube 300 from rotating within the toothbrush 200.

The seal 310 (e.g., a tapered fitting) may be disposed on the end of the cartridge 300 is configured to press into the tapered toothbrush body cavity 224 causing a seal which causes the toothpaste to only travel in one direction through the cartridge tube 300 and into the head 210 of the toothbrush 200. At the end of the cartridge 300 is a catch stop 311 hindering rotation.

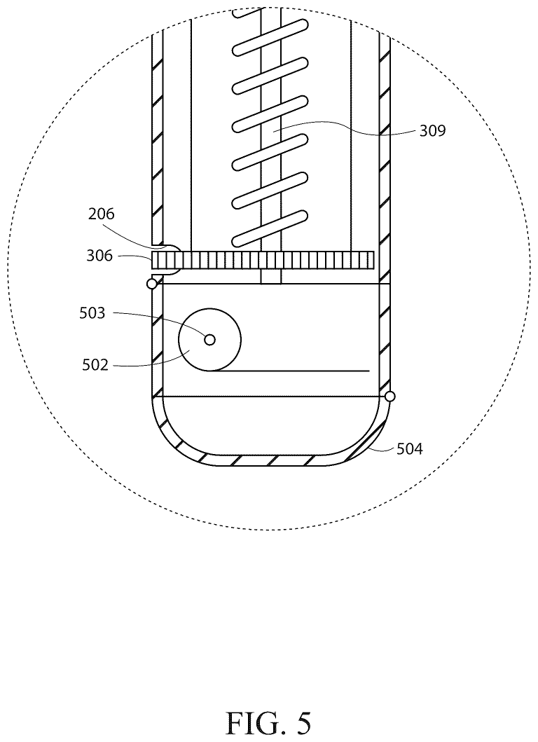

Referring to (FIG. 5) a floss cover 504 of the apparatus 100 of FIG. 1 is shown. In aspects, the apparatus 100 may include a hinged floss cover 504. The floss cover 504 may be located within the hatch 208 at the back of the toothbrush 200. The cover may flip open revealing floss within the hatch 208 of the toothbrush 200. In aspects, the apparatus 100 may include a floss roll 502 (FIG. 7). The floss roll 502 may be located on a second spindle 503 within the hatch 208. In aspects, the apparatus 100 may include a floss cutter 501. The floss cutter may be molded into the plastic of the hatch 208 and located just under the flip cap at the back of the toothbrush 200.

It should be understood that the foregoing description is only illustrative of the present disclosure. Various alternatives and modifications can be devised by those skilled in the art without departing from the disclosure. Accordingly, the present disclosure is intended to embrace all such alternatives, modifications, and variances. The embodiments described with reference to the attached drawing figures are presented only to demonstrate certain examples of the disclosure. Other elements, steps, methods, and techniques that are insubstantially different from those described above are also intended to be within the scope of the disclosure.

What is claimed is:

1. An apparatus for dispensing toothpaste comprising:
a toothbrush including:
a head including bristles, a cartridge cavity, and a tube extending from the cartridge cavity to the bristles, wherein the tube extends to the end of the bristles and is configured for dispensing toothpaste, wherein the tube includes a proximal end and a distal end, the distal end of the tube includes a cap with cross slices configured to stop toothpaste from oozing out;
a body extending from the head, the body including a toothbrush cavity;
a gear configured to advance the toothpaste; and
a hatch configured to create a positive pressure into the cartridge forcing the cartridge forward, creating a tapered seal within the front of the toothbrush cavity; and
a cartridge configured for providing toothpaste to the toothbrush for dispensing, the cartridge includes one or more gears, a plunger, a cartridge tube, and a seal, the gear is located on a back surface of the cartridge and is attached to an inner spindle, the gear makes contact with the outer gear located on the body of the toothbrush, the plunger rotates around the inner spindle which attaches to the gear, the plunger rotates forward as the gears are turned, pushing the toothpaste from the cartridge to the end of the toothbrush, the cartridge tube has two or more indentations on a first end that are configured to stop the cartridge tube from rotating within the toothbrush, the seal includes a tapered fitting on the end of the cartridge is designed to press into the tapered toothbrush cavity causing a seal which only allows the toothpaste to travel through the cartridge tube and into the head of the toothbrush.

2. An apparatus for dispensing toothpaste comprising:
a toothbrush including:
a head including bristles, a cartridge cavity, and a tube extending from the cartridge cavity to the bristles.

3. The apparatus of claim 2, wherein the tube extends to the end of the bristles and is configured for dispensing toothpaste.

4. The apparatus of claim 3, wherein the tube includes a proximal end and a distal end, the distal end of the tube includes a cap with cross slices configured to stop toothpaste from oozing out.

5. The apparatus of claim 4, wherein the toothbrush further comprising:
a body extending from the head, the body including a toothbrush cavity; and
a gear configured to advance the toothpaste.

6. The apparatus of claim 5, the toothbrush further comprising:
a hatch configured to create a positive pressure into the cartridge forcing the cartridge forward, creating a tapered seal within the front of the toothbrush cavity.

7. The apparatus of claim 6, further comprising:
a cartridge configured for providing toothpaste to the toothbrush for dispensing, the cartridge includes one or more gears, a plunger, a cartridge tube, and a seal.

8. The apparatus of claim 7, wherein the cartridge further comprises:
a seal, wherein the gear is located on a back surface of the cartridge and is attached to an inner spindle.

9. The apparatus of claim 8, wherein the gear makes contact with the outer gear located on the body of the toothbrush.

10. The apparatus of claim 9, wherein the plunger rotates around the inner spindle which attaches to the gear.

11. The apparatus of claim 10, wherein the plunger rotates forward as the gears are turned, pushing the toothpaste from the cartridge to the end of the toothbrush.

12. The apparatus of claim 11, wherein the cartridge tube has two or more indentations on a first end that are configured to stop the cartridge tube from rotating within the toothbrush.

13. The apparatus of claim 12, wherein the seal includes a tapered fitting on the end of the cartridge is designed to press into the tapered toothbrush cavity causing a seal which only allows the toothpaste to travel through the cartridge tube and into the head of the toothbrush.
